(19) United States
(12) Patent Application Publication
(10) Pub. No.: US 2008/0152313 A1
(43) Pub. Date: Jun. 26, 2008

(54) Image processing apparatus

(75) Inventors: Hiroshi Sakurai, Fujisawa (JP); Masaru Takahashi, Hayama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 12/000,954

(22) Filed: Dec. 19, 2007

(30) Foreign Application Priority Data
Dec. 25, 2006 (JP) 2006-346927

(51) Int. Cl. H04N 7/26

(52) U.S. Cl. 386/109; 386/E05.001

(57) ABSTRACT

An image processing apparatus wherein a first encoder records one of compressed image data having a low bit rate in a first recording medium and at the same time, rate control information for the first encoder is stored in a CPU, and one of the compressed image data having a high bit rate is recorded in a second recording medium. The second compressed image data of the high bit rate is expanded, image data obtained by expanding the high-bit-rate compressed image data with use of the previously-stored rate control information of the first encoder is again encoded by the first encoder, only quality degradation part of the image data is replaced with the re-encoded compressed image data and then recorded in the recording medium.

### INCORPORATION BY REFERENCE

The present application claims priority from Japanese application JP2006-346927 filed on Dec. 25, 2006, the content of which is hereby incorporated by reference into this application.

### BACKGROUND OF THE INVENTION

The present invention relates to an image processing apparatus which has recording and reproducing functions.

Related arts belonging to the technical field of the present application include, for example, JP-A-08-046959, JP-A-2005-151173, JP-A-2006-245867, JP-A-10-191255, and JP-A-2006-237846. These Publications are briefly explained as their abstracts which follow.

JP-A-08-046959 is explained as its abstract which follows.

PURPOSE: To attain the improvement of efficiency in work for executing high definition processing in encoded data of animation.

CONSTITUTION: A plurality of encoders 2, 3 and 4 which respectively and simultaneously compress and encode the common moving image, respectively generate the reference pictures of same code quantity and generate non-reference pictures with respectively different code quantity and a composite part 8 which connects encoding data optionally selected from encoding data which is obtained by the respective encoders 2, 3 and 4 by picture group unit and stores it to a data storing medium 9 as a last output stream are provided. The compression encoding of the moving image is made to be acceptable for only one time execution by appearance and work which requires human intervention comes to be only work for selecting optional encoding data from encoding data obtained by the respective encoders 2, 3 and 4 so that the improvement of work efficiency is realized.

JP-A-2005-151173 is explained as its abstract which follows.

PROBLEM TO BE SOLVED: To realize a method of reproducing both coded data of the same moving picture contents in collaboration with each other: one coded at a high bit rate and recorded in a first recorder and the other coded at a low bit rate and recorded in a second recorder.

SOLUTION: A decoder 104 reproduces coded data recorded in a first recorder 102. When it stops reproducing thereafter, a controller 105 writes the time stamp of a packet next to the last reproduced packet in the header of the coded data as a reproduction start point, together with this write time in the header as an update time of the reproduction start point. The controller 105 operates to synchronize the reproduction start time of coded data recorded in a second recorder 103 and the update time of the reproduction start point with the first recorder 102.

JP-A-2006-245867 is explained as its abstract which follows.

PROBLEM TO BE SOLVED: To provide an image recording/reproducing apparatus which can control a storage capacity by a user without recompressing a recorded video signal to the utmost.

SOLUTION: The image recording reproducer has two or more of encoders encoding the video signal at severally different bit rates, and recording the encoded video signal on a recording medium. The image recording reproducer further has a means for deleting an image data recorded through either encoder during a recording on the recording medium or after the completion of the recording.

JP-A-10-191255 is explained as its abstract which follows.

PROBLEM TO BE SOLVED: To provide an image processing apparatus with a simple arrangement, which can previously prevent the disturbance of output owing to the damage of data by compressing, encoding and recording input data at a first bit rate and a second bit rate lower than the first bit rate.

SOLUTION: The apparatus compresses/encodes input data at a first bit rate and at a second bit rate lower than the first bit rate to be recorded in a recording medium (5). Thus, in a production mode, when the data compressed/encoded at the first bit rate is damaged, the apparatus can decompose, decode and output the data compressed/encoded at the second bit rate and can previously prevent the disturbance of an output generated by the data damage. As a result, with a simple arrangement, the apparatus can previously prevent the disturbance of the output caused by the data damage.

JP-A-2006-237846 is explained as its abstract which follows.

PROBLEM TO BE SOLVED: To provide an image processing apparatus which can control the optimum code amount in accordance with a recording medium.

SOLUTION: The apparatus is provided with an input means for inputting motion image data, coding means for coding the motion image data, first recording means for recording the coded motion image data outputted from the coding means into a first recording medium, second recording means for recording the coded motion image data outputted from the coding means into a second recording medium, selecting means for selecting any one of the first recording medium and the second recording medium to cause the selected medium to record the coded motion image data, coding amount control means for controlling amount of the generated codes of the coded motion image data to be outputted from the coding means, and changing means for changing the control procedures by the coding amount control means in response to a result of selection of the selecting means.

### SUMMARY OF THE INVENTION

Two pass encode is known as a method of compressing and recording an image. In the 2 pass encode, an image is once encoded, and again encoded on the basis of rate control information or the like obtained by the first encoding to enhance the quality of the image.

In the prior arts, however, it is required to store original image data to be compressed, and thus a large scale of apparatus becomes necessary. For this reason, it is hard to employ the 2 pass encode in such a camera that is, in many cases, carried with the user and its miniaturization is demanded.

In recent image compression, meanwhile, it is also possible to record an image at a high bit rate and an image at a low bit rate at the same time. In this case, the 2 pass encode can be employed while eliminating the need of storing the original data of the low-bit-rate image as a compression target because the original data of the high-bit-rate image can be used simultaneously as the original data of the low-bit-rate image.

To this end, such an image processing apparatus of a simple arrangement is demanded that can use a plurality of media and can record a high quality of image even at a low bit rate.

It is therefore an object of the present invention to provide an image processing apparatus which can record a high quality of image.

The above object is attained, as an example, by simultaneously recording an image at a high bit rate and an image at a low bit rate and generating a high-quality image of a low bit rate in a manner that a part of the low-bit-rate image is replaced with the high-bit-rate image or the high-bit-rate image is re-encoded, and recording the high-quality image of a low bit rate thus obtained.

Details of the present invention are as set forth in claims.

In accordance with the present invention, an image processing apparatus can obtain a high quality of image. As an example, the apparatus can record a high quality of image of a low bit rate, reduce the capacity of a medium for an image to be recorded therein, and also can prolong a recording time with a higher image quality.

Problems, arrangements, and effects other than the aforementioned problem, arrangement, and effects of the present invention will be explained in embodiments which follow.

Other objects, features and-advantages of the invention will become apparent from the following description of the embodiments of the invention taken in conjunction with the accompanying drawings.

### BRIEF DESCRIPTION OF THE DRAWINGS

FIG. 1 shows a block diagram of an image processing apparatus in accordance with a first embodiment of the present invention;

FIG. 2 diagrammatically shows the operation of the image processing apparatus in FIG. 1;

FIG. 3 shows a block diagram of an image processing apparatus in accordance with a second embodiment of the present invention;

FIG. 4 shows a block diagram of an image processing apparatus in accordance with a third embodiment of the present invention;

FIG. 5 shows a block diagram of an image processing apparatus in accordance with a fourth embodiment of the present invention;

FIG. 6 diagrammatically shows the operation of the image processing apparatus in FIG. 5;

FIG. 7 shows a block diagram of an image processing apparatus in accordance with a fifth embodiment of the present invention;

FIG. 8 diagrammatically shows the operation of the image processing apparatus in FIG. 7;

FIG. 9 shows a block diagram of an image processing apparatus in accordance with a sixth embodiment of the present invention;

FIG. 10 shows a block diagram of an image processing apparatus in accordance with a seventh embodiment of the present invention;

FIG. 11 diagrammatically shows the operation of the image processing apparatus in FIG. 10;

FIG. 12 shows a block diagram of an image processing apparatus in accordance with an eighth embodiment of the present invention;

FIG. 13 shows a block diagram of an image processing apparatus in accordance with a ninth embodiment of the present invention; and

FIG. 14 is a block diagram for explaining a stream controller in FIG. 13.

### DETAILED DESCRIPTION OF THE EMBODIMENTS

Embodiments of the present invention will be explained with reference to the accompanying drawings.

### Embodiment 1

FIG. 1 shows a block diagram of an image processing apparatus in accordance with an embodiment of the present invention, wherein reference numeral 1 denotes a lens; numeral 2 denotes a sensor; 3 denotes a camera signal processor, 4 an image device which includes the elements 1,2, and 3; 5 a first encoder for image compression, 6 a second encoder for image compression, 7 a memory controller, 8 a memory for storing image data, 9 a CPU, 50 a rate control information holder, 51 an image degradation determiner, 10 a stream controller, 11 a first recording medium, 12 a second recording medium, 13 a buffer memory. As an example, an optical disk (such as DVD) may be used as the first recording medium 11 and a hard disk may be used as the second recording medium 12. However, the present invention is not limited to the above example. The first encoder 5 may be used to compress an image of an MPEG2 scheme and the second encoder 6 may be used to compress an image of an H.264 format, as an example. However, the present invention is not limited to this example.

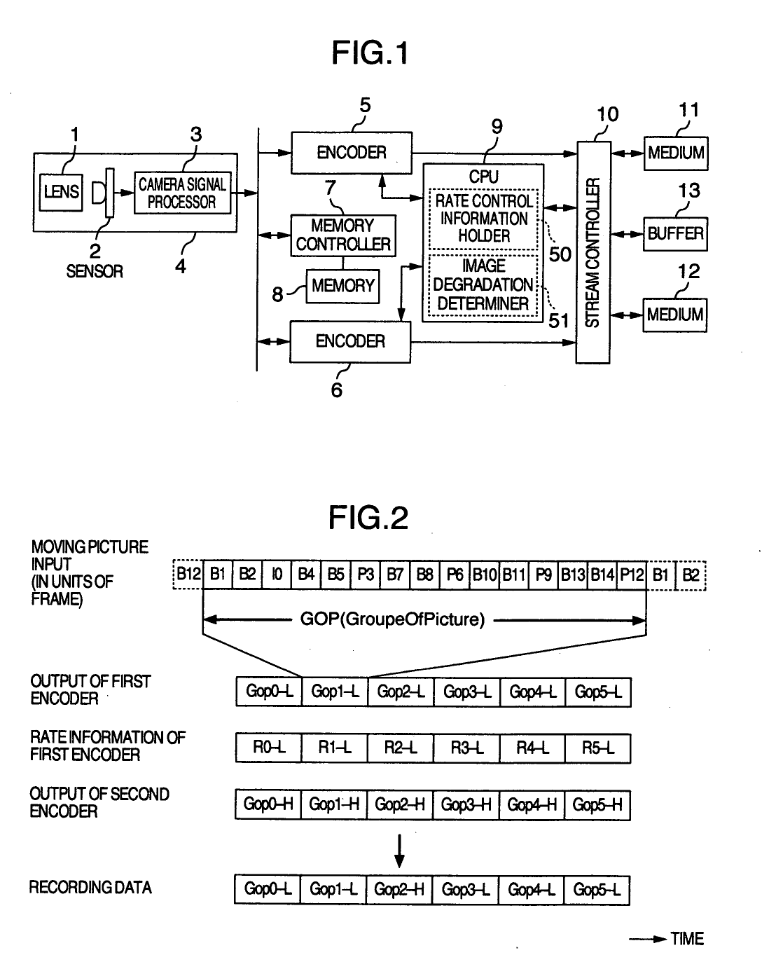

In the drawing, digital image data output from the image device 4 is stored in the memory 8 via the memory controller 7. The stored digital image data is read out from the memory 8 at predetermined timing, and then supplied to the first and second encoders 5 and 6 respectively. An image output of the first encoder 5 is compressed with a low bit rate, applied to the stream controller 10, once stored in the buffer memory 13, and then written in the first recording medium 11. At the same time as the above, an image output of the second encoder 6 is compressed with a high bit rate, once stored in the buffer memory 13 under control of the stream controller 10 as in the case of the first encoder output, and then recorded in the second recording medium 12. The CPU 9 stores a generated code amount from the first encoder 5 into the rate control information holder 50 as rate control information for control of the generated code amount, determines at the image degradation determiner 51 an image degradation position on the basis of the rate control information, and stores the image degradation position therein. Explanation will next be made as to the operation of the apparatus after recording the image. The stream controller 10 reads out the compressed image data recorded in the first recording medium and the compressed image data recorded in the second recording medium at the same time. When the read-out image degradation position is not the aforementioned detected image degradation position, the stream controller 10 again writes the compressed image data recorded in the first recording medium in the first recording medium 11 without processing the data. When the read-out position is the aforementioned image degradation position, the stream controller 10 replaces it with the compressed image data read out from the second recording medium, and records it in the first recording medium 11. As a result, an image degradation part in the low-bit-rate image recorded in the first recording medium 11 is replaced with an image of a high bit rate, thus enabling recording of a high quality of image. In this connection, when the aforementioned replacement is carried out, for example, on a GOP (Group Of Picture) basis, a higher quality of image can be obtained. This manner is shown in FIG. 2. It is assumed in FIG. 2 that an input image is encoded as I_picture, P_picture and B_picture respectively, and that image data generally corresponding to about 15 pictures is as a GOP unit. In the GOP arrangement, a GOP unit having large picture quality degradation part is replaced with a high quality of compression data. In an example of FIG. 2, a GOP2-L can be replaced with a GOP2-H and be written in a recording medium. Determination of image quality degradation part on each GOP basis is made on the basis of Q parameter information. When the Q parameter information is deviated from a predetermined value, it is determined that the image includes a very fast movement or a fine pattern with many high frequency components or the like, and thus the image quality is determined to be deteriorated.

Generally speaking, Q parameter information means a quantization coefficient in the units of macro block (16×16 pixels). The larger the quantization coefficient is, the larger the number of quantization steps is, and the more the image quality is degraded. The Q parameter information is information of a macro block unit, so that, when the determination of image quality degradation is made by averaging information of a picture of a GOP, the quantity of information can be made small.

In the GOP arrangement of FIG. 2, B_picture shown by B0, B1 can be generated with use of P12 of the previous GOP as a predictive image. However, since data replacement is made on the GOP basis in the present embodiment, it is desirable to generate a closed GOP not by using P12 of the previous GOP but by using I2 of the current GOP as a predictive image.

The present embodiment has been carried out by recording the output of the second encoder 6 in the second recording medium 12 in the form of fully compressed image data. However, such an arrangement is also possible as to record only part of the image data corresponding to the aforementioned detected image degradation position information, and read it from the second recording medium 12 when the position is the replacement position of the compressed image data recorded by the first encoder 5, and replace the compressed image data recorded by the first encoder 5 with the output of the second recording medium 12. Although the above explanation has been made in connection with the case where low bit rate data is recorded in the first recording medium 11 and high bit rate data is recorded in the second recording medium 12, it goes without saying that the recording relation therebetween can be exchanged.

### Embodiment 2

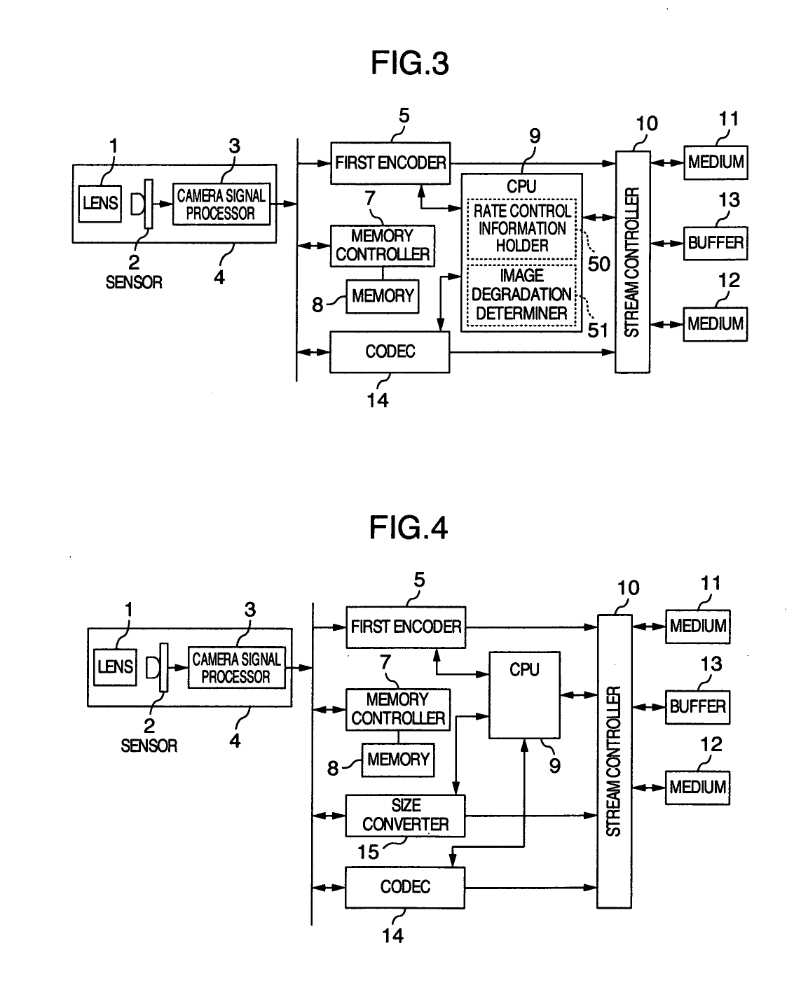

FIG. 3 shows a second embodiment. FIG. 3 is the same as the first embodiment of FIG. 1, but different therefrom in that the second encoder 6 is replaced with a codec 14. Thus, constituent elements of FIG. 3 having the same functions as those in the first embodiment are denoted by the same reference numerals, and explanation thereof is omitted.

The present embodiment is substantially the same as the first embodiment until input data is recorded in the first and second recording media. Thus explanation of the present embodiment until the data is recorded therein is omitted, and explanation will start from reading out the recorded data. The rate control information, which includes the Q parameter information and stuffing information, is stored in the rate control information holder 50. The image quality degradation position is detected by the image degradation determiner 51 and stored therein on the basis of information stored in the rate control information holder. Explanation will then be made as to the operation of the apparatus after the image is recorded. Data recorded in the first and second media 11 and 12 at the same time are read out, so that the compressed image data read out from the second recording medium is supplied to the codec 14 via the stream controller 10. The stream controller 10 controls the timing of data output by performing buffering operation using the buffer memory 13. The codec 14 expands the compressed image data to generate decoded image data. The image data is stored in the memory 8 and read out into the first encoder 5 at predetermined timing under control of the memory controller 7. The first encoder again encodes the image data for image quality improvement on the basis of the rate control information holding image data about the image quality degradation position detected in the record mode. The re-encoded data is supplied to the stream controller 10 and is replaced with the compressed stream read out from the first recording medium. As a result, as in the first embodiment, a high quality of image can be recorded with a low bit rate.

Explanation will then be made as to image quality improvement upon the re-encoding. The image quality improvement upon the re-encoding is carried out based on the rate control information previously stored. For example, by allocating a high code amount allocated in re-encoding mode to one of pictures in the GOP unit having a high average of Q parameter values or by allocating a small code amount to one of pictures having a large stuffing amount; a high quality of compressed image can be obtained. When the Q parameter value is referred to in the units of macro block or in the units of a plurality of macro blocks and the code amount and code amount allocation is made in the units of macro block or in the units of a plurality of macro blocks, a higher quality of compressed image can be recorded. Although the above explanation has been made in connection with the case where the stuffing information is stored in the record mode in the present embodiment, the stuffing information can also be stored in a decode mode prior to the re-encode mode.

In accordance with the present embodiment, a high quality of image can be recorded while avoiding an increase in the bit rate and keeping a low bit rate, as in the first embodiment.

### Embodiment 3

FIG. 4 shows a third embodiment. The embodiment is substantially the same as the second embodiment of FIG. 3, but is different therefrom in that the third embodiment includes a size converter 15. In the third embodiment, constituent elements having the same functions as those in the second embodiment are denoted by the same reference numerals and explanation thereof is omitted.

The present embodiment is similar to the second embodiment until data is recorded in the first recording medium, that is, until an image of a low bit rate and of an SD size (e.g., 720×480) is recorded or the image degradation position information and rate control information are stored in the CPU. Meanwhile, an HD size of compressed image data is recorded in the second recording medium. Data read out from the second recording medium is input to the codec 14 via the second recording medium 12 and is stored in the memory 8 via the memory controller 7 as an HD (e.g., 1920×1080) size of image. An HD size of video data read out from the memory 8 at predetermined timing is down converted to an SD size by the size converter 15. A video signal down-converted to the SD size is re-encoded for image quality improvement on the basis of the rate control information holding image data of the image quality degradation position detected by the first encoder in the record mode. The re-encoded data is supplied to the stream controller 10, where the data is replaced with a compressed stream read out from the first recording medium. Even in the present embodiment, the operation of the apparatus in the re-encode mode is the same as in the embodiment of FIG. 3, and explanation thereof is omitted.

With the aforementioned arrangement, similarly to the second embodiment, the present embodiment can record an image at a low bit rate.

### Embodiment 4

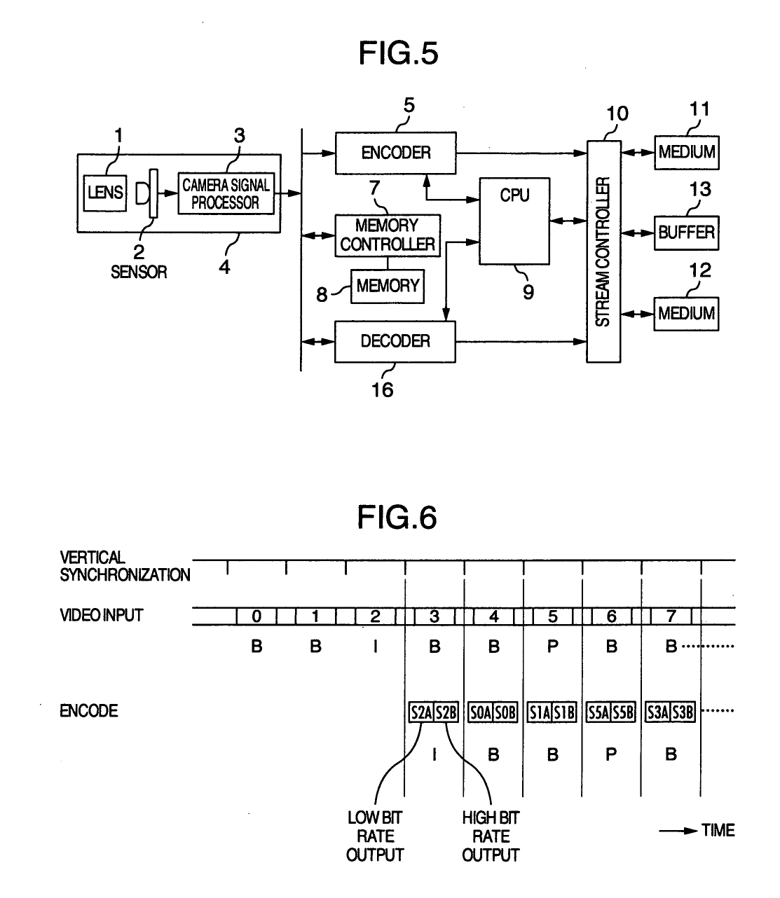

FIG. 5 shows a fourth embodiment. The present embodiment is substantially the same as the embodiment of FIG. 3, but different therefrom in that the second encoder 6 is replaced with a decoder 16. The other arrangement is substantially the same as the embodiment of FIG. 3, constituent elements having the same functions as those in FIG. 3 are denoted by the same reference numerals, and explanation thereof is omitted.

In the present embodiment, the first encoder 5 generates a compressed image of a low bit rate and a compressed image of a high bit rate on a time division basis to be recorded in the first and second recording media 11 and 12 respectively. An example of recording timing will be explained by referring to FIG. 6. A digital image signal input from the image device 4 is stored in the memory 8 under control of the memory controller 7. In FIG. 6, when input images at given timing are denoted by 0, 1, 2 . . . , encoding starts from the next frame to the image data denoted by 2 to be encoded as an I picture stored in the memory 8. At this time, the first encoder 5 outputs an image signal S2A as a compressed image of a low bit rate, the image is recorded in the first medium 11 under control of the stream controller 10 and at the same time, the image quality degradation position information and the rate control information detected from the rate control information are stored in the CPU 9. Thereafter, the first encoder 5 outputs an image signal S2B as a compressed image of a high bit rate to be recorded in the second recording medium under control of the stream control circuit 10. Compressed image data is read out from each recording medium, a high bit rate of image is expanded by the decoder 16 and recorded in the memory 8. Then similarly to the embodiment of FIG. 3 and 4, an image of a low bit rate is generated from the decomposed image read out from the memory 8 by re-encoding the image on the basis of the rate control information, and is recorded in the first recording medium 11. Since a decoder 16 is used in place of the codec 14 shown in the embodiments of FIGS. 3 and 4 in the present embodiment, the embodiment is featured in that a circuit scale can be made small.

In accordance with the present embodiment, a high quality of image of a low bit rate can be recorded with a small circuit scale.

### Embodiment 5

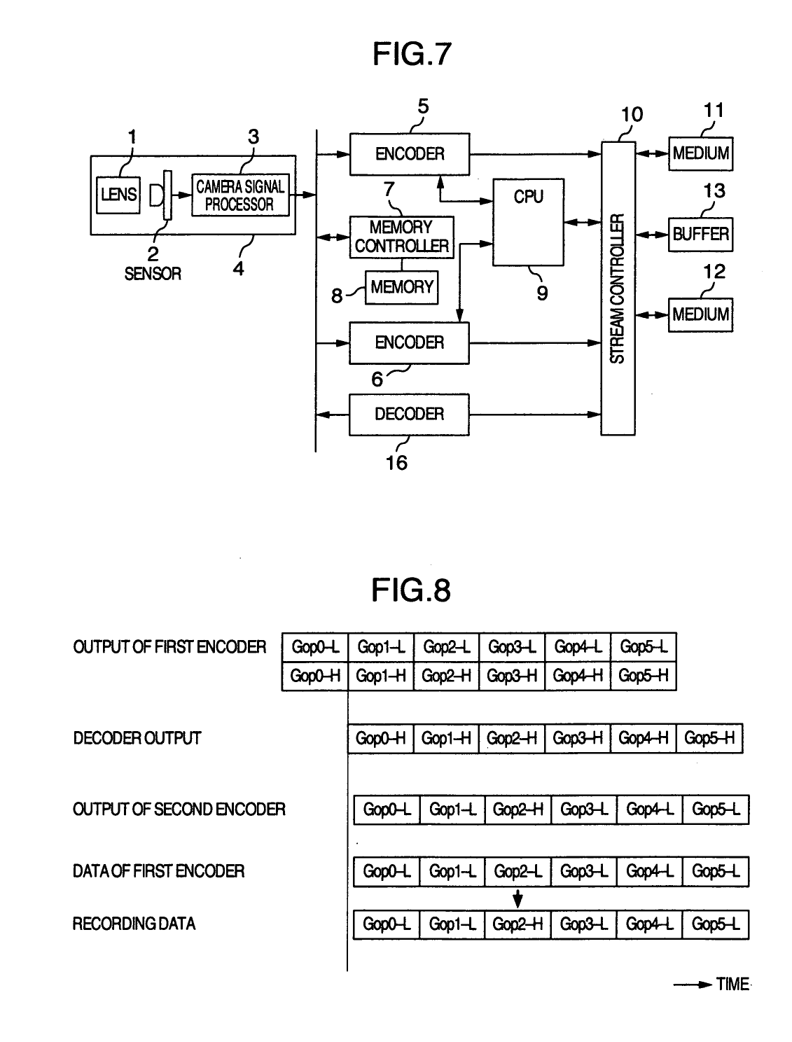

FIG. 7 shows a fifth embodiment which includes first and second encoders 5 and 6 and a decoder 16. The other arrangement is the same as the foregoing embodiment, constituent elements having the same functions are denoted by the same reference numerals, and explanation thereof is omitted.

In the present embodiment, the first encoder 5 generates an image of a high bit rate and an image of a low bit rate on a time division basis and these images are recorded in the first and second media 11 and 12 respectively, as in the fourth embodiment. At this time, the operation of recording the rate control information of the high quality of low-bit-rate image in the CPU 9 at the same time and the operation of generating a high quality of low-bit-rate compressed image by re-encoding are similar to those in the second, third, and fourth embodiments.

FIG. 8 is a diagram for explaining the operation of the present embodiment. When the apparatus finishes reading one GOP, the apparatus reads out image data of a high bit rate and image data of a low bit rate at the same time, expands the high-bit-rate image data at the decoder 16, stores it in the memory, again compresses it on the basis of the rate control information previously stored at the time of generating the low-bit-rate image at the second encoder 6 to generate compressed data of a high quality of compressed image data of a low bit rate, and supplies the compressed image data to the stream controller 10. At the same time with the above, the low-bit-rate compressed data recorded in the first recording medium 11 is sent to the stream controller. The stream controller replaces the low-bit-rate compression data of the image quality degradation part with the above re-compressed low-bit-rate data, and records it in the second recording medium 12.

As has been explained above, the present embodiment can record a high quality of compressed image of a low bit rate and after recording, the present embodiment also can attain the recording operation without involving a high quality of converting operation.

### Embodiment 6

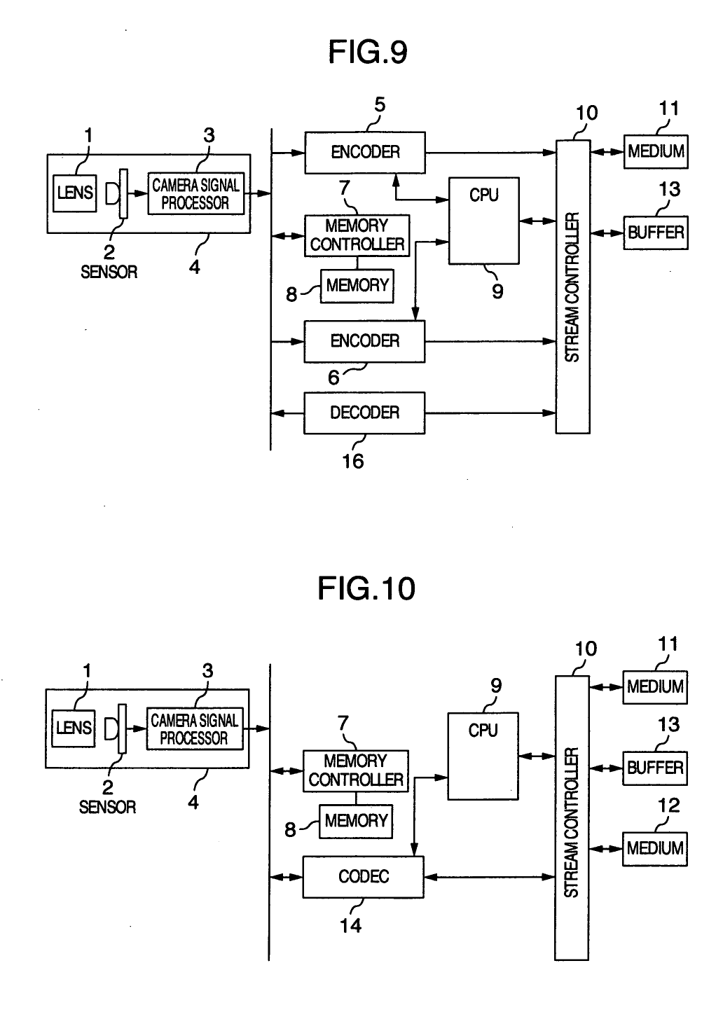

FIG. 9 shows a sixth embodiment. The present embodiment is substantially the same as the fifth embodiment, except that the recording media in the fifth embodiment is replaced with a single recording medium 11. In the sixth embodiment, constituent elements having the same functions as those in the fifth embodiment are denoted by the same reference numerals, and explanation thereof is omitted.

In the present embodiment, only a single recording medium is provided, the first encoder 5 generates an image of a high bit rate and an image of a low bit rate on a time division basis and these images are recorded in the recording medium 11 as in the fourth embodiment. At this time, the operation of recording the rate control information of the low-bit-rate image in the CPU 9 at the same time and the operation of generating the high quality of compressed image of low bit rate by re-encoding are substantially the same as those in the second, third, fourth, and fifth embodiments. The recording medium 11 in the present embodiment is required to have a high speed operation, since the medium requires simultaneous recording of two compressed streams, simultaneous reading thereof when a high-quality of compressed image of a low bit rate by re-encoding after the recording is generated, and treating of the two streams. Further, since two compressed streams are recorded, a large capacity is required from a viewpoint of its capacity.

In accordance with the present embodiment, since it is required to have only a single recording medium, the embodiment can record a small and high quality of compressed image of a low bit rate.

### Embodiment 7

FIG. 10 shows a seventh embodiment. The present embodiment is substantially the same as the other foregoing embodiments, except that a single codec 14 can have encoding and decoding functions. Constituent elements in the present embodiment having the same functions are denoted by the same reference numerals and explanation thereof is omitted.

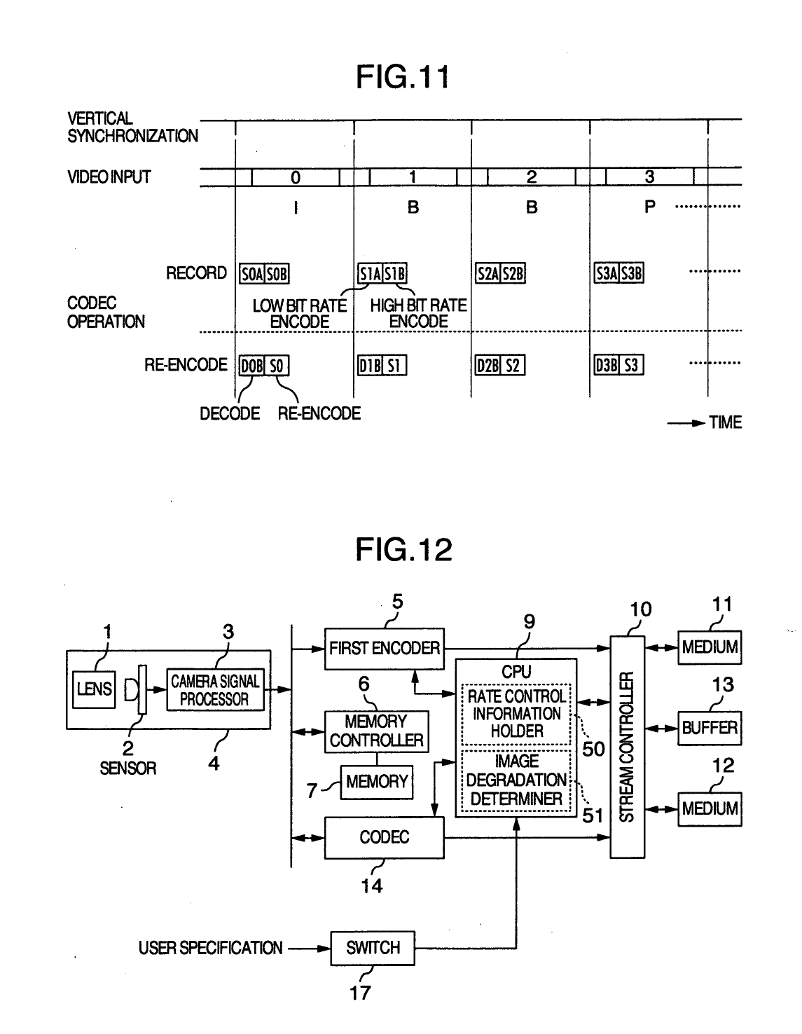

In the present embodiment, the codec 14 generates a compressed image of a low bit rate and a compressed image of a high bit rate on a time division basis, the rate control information of the low-bit-rate image is recorded in the CPU 9 and at the same time, the images are recorded in the recording media 11 and 12 respectively. Thereafter, reading of the recorded compressed stream is carried out in such a manner as mentioned in the other embodiments. However, in the re-encode mode, the codec 14 performs decoding and encoding operations on a time division basis. FIG. 11 is a diagram for explaining the operation of the present embodiment, wherein compressed image data of a low bit rate and compressed image data of a high bit rate are generated respectively as S0A, . . . and S0B, . . . and recorded. Next, the high-bit-rate compressed image data read out from the recording medium 12 is supplied to the codec 14 via the stream controller 10. The codec 14, as shown by the operation of the re-encode mode in FIG. 11, performs decoding operation shown by D0B . . . and re-encoding operation shown by S0, . . . on a time division basis. Since the re-encoding operation based on the previously-stored rate control information at the time of generating the low-bit-rate image is carried out in such a manner as mentioned in the other embodiments, explanation thereof is omitted.

As has been explained above, in accordance with the present embodiment, compression and expansion can be implemented only by the codec 14, a circuit scale can be made small and a high quality of compressed image of a low bit rate can be recorded with a low cost.

### Embodiment 8

FIG. 12 shows an eighth embodiment which is arranged so that a user can determine picture quality degradation. The present embodiment performs similar operation to the embodiment of FIG. 3, except that such a switch 17 that the user can specify an image quality degradation part is added in the embodiment of FIG. 3. Thus constituent elements in the present embodiment having the same functions as those in the embodiment of FIG. 3 are denoted by the same reference numerals and explanation thereof is omitted.

The present embodiment is substantially the same as the embodiment of FIG. 3 until the Q parameter information and the stuffing information are included in the rate control information and images are recorded in first and second recording media. However, since the image quality degradation position is specified by the user, it is unnecessary to store its data. After the data is recorded, the user reproduces the low-bit-rate image. When the user determines while watching a monitor or the like that image quality degradation is great, the user turns the switch 17 ON to store information about the image quality degradation position in the CPU. When user completes the reproduction, the present embodiment, on the basis of the image quality degradation position information, expands compressed image data of a high bit rate and generates a high quality of compressed image data of a low bit rate from the expanded data. Since generation of the high-quality and low-bit-rate compressed image data is carried out in such a manner as in the operation of FIG. 3, explanation thereof is omitted. Since the image quality improving operation by re-encoding is carried out in the units of GOP, it is only required to re-encode all the GOPs including an image whose quality degradation is determined by the user.

In the present embodiment, since the user can confirm an image quality and then the confirmed part can be subjected to the image quality improving operation, a compressed image highly satisfied by the user can be generated. Although such an arrangement that the user can specify an image quality degradation position has been obtained from the embodiment of FIG. 3 as in the present embodiment, it goes without saying that it can be implemented with use of the other embodiments of the present invention.

### Embodiment 9

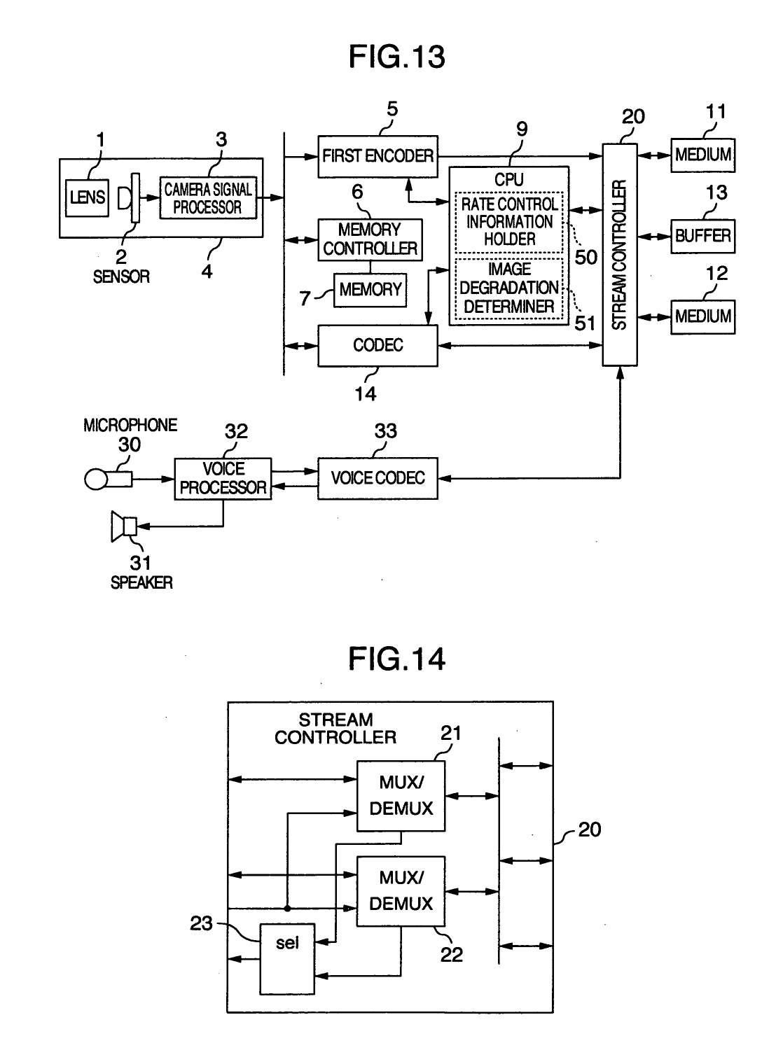

FIG. 13 shows a ninth embodiment in which a voice processing section is added to the embodiment of FIG. 3. Constituent elements in the present embodiment having the same functions as those in the embodiment of FIG. 3 are denoted by the same reference numerals and explanation thereof is omitted. Explanation will first be made as to the recording operation of the present embodiment. A voice or audio signal is input from a microphone 30 to a voice or audio processor (hereinafter referred to a voice processor) 32 to obtain a suitable level of digital voice data therein. Thereafter, the digital voice data is sent to a voice or audio codec (hereinafter referred to a voice codec) 33 to generate compressed voice or audio data, which in turn is supplied to a stream controller 20. Meanwhile, with respect to video or audio data, compressed image data of a high bit rate and compressed image data of a low bit rate are generated as already explained in FIG. 3, and these data are supplied to the stream controller 20 like the voice or audio signal. The two pieces of compressed image data and the voice or audio compression data supplied to the stream controller 20 are supplied to MUX/DEMUXs 21 and 22 of the stream controller 20 shown by a detailed diagram in FIG. 14 respectively to generate system streams including the video and the voice or audio data. The two generated system streams are recorded in the recording media 11 and 12 respectively. At this time, the generation timing and recording timing of the system streams are adjusted by buffering the streams under control of the buffer 13. Explanation will next be made as to the re-encoding operation. The two system streams are read out from the recording media 11 and 12 and then separated into voice or audio compression data and image compression data by the respective MUX/bEMUXs 21 and 22 while the timing of the streams is adjusted by the buffer 13. At this time, the voice or audio data is previously stored in the buffer 13. After the separation, the high-bit-rate compressed image data is decoded and re-encoded on the basis of the rate control information of the low-bit-rate image, which explanation is similar to the explanation in FIG. 3. The re-encoded compressed image data having an improved quality is again supplied to the stream controller 20 so that the MUX/DEMUX 21 generates a system stream from the previously-stored voice compression data and the above compressed image data and the system stream is recorded in the recording medium 11. When it is desired to reproduce the video and the voice or audio data, any of the voices or audio data of the two system streams is output, to which end a selector 23 is provided.

As has been explained in the foregoing, the present embodiment can record a high quality of image data of a low bit rate and compressed voice or audio data as a single stream conforming to a compression standard.

Although explanation has been made in connection with the case where only a single piece of compression voice or audio data is generated in the present embodiment, two pieces of compression data may be generated similarly to image data. In this case, two voice codecs can be prepared. When the voice codec 33 is operated on a time division basis, however, the above can be implemented while eliminating the need of increasing its hardware. Further, the present embodiment has been arranged to once record the low-bit-rate compressed image data and the high-bit-rate compressed image data as system streams respectively. When only the low-bit-rate compressed image data is recorded as a system stream and the high-bit-rate compressed image data is recorded as only image data as an example, however, the present embodiment may be arranged with the MUX/DEMUX 22 and the selector 23 removed.

The compression/expansion system includes a motion picture compression format such as MPEG-1, MPEG-2, MPEG-4 or H.264. However, the present invention is not limited to the specific compression system, but any compression system may be effectively applied to any of the embodiments of the present invention, as a matter of course.

The present invention is not limited to the aforementioned embodiments, but the invention may include various types of modifications thereof. For example, the foregoing embodiments have been detailed for the purpose of easy understanding of the present invention, and thus the invention is not necessarily limited to the embodiments including the entire arrangements. That is, part of the arrangement of one of the embodiments may be replaced with the arrangement of the other embodiment, or the arrangement of one of the embodiments may be added to the arrangement of the other embodiment.

1. An image processing apparatus comprising:
an image device for generating a digital video signal from a sensor;
first and second encoders for performing image compressing operation;
first and second recorders for recording outputs of said first and second encoders in first and second recording media; and
a rate control information storage for use when data is compressed by said first encoder;
wherein compression data generated by the first encoder is replaced with compression data generated by the second encoder according to rate control information.

2. An image processing apparatus comprising:
an image device for generating a digital video signal from a sensor;
an encoder for performing image compressing operation;
a codec for selectively switching between image compression and image expansion;
first and second recorders for recording an output of said encoder and an output of said codec in first and second recording media;
a rate control information storage for use when data is compressed by said encoder;
wherein, after the codec is switched, compression data generated by said codec is expanded, and thereafter compression data generated by the encoder is replaced with data re-compressed and generated by the encoder according to rate control information, and then recorded.

3. An image processing apparatus according to claim 2, further comprising a size converter, wherein an image corresponding to a compression or expansion of an HD image generated from said codec is converted by said size converter to an SD size, and thereafter compression data generated by the encoder is replaced with data re-compressed and generated by the encoder according to rate control information, and then recorded.

4. An image processing apparatus according to claim 2, wherein said encoder generates two pieces of compression data having different bit rates on a time division basis, the rate control information is stored when one of said two pieces of compression data having the lower bit rate is compressed, one of the two pieces of compression data having the higher bit rate is expanded by said codec, and thereafter one of the two pieces of compression data having the lower bit rate according to said rate control information is replaced with data re-compressed and generated by the encoder according to said rate control information, and then recorded.

5. An image processing apparatus comprising:
an image device for generating a digital video signal from a sensor;
first and second encoders for performing image compressing operation;
a decoder for performing image expanding operation;
first and second recorders for recording outputs of said encoders in first and second recording media; and
a rate control information storage for use when data is compressed by said first encoder;
wherein said first encoder generates two pieces of compression data having different bit rate on a time division basis, rate control information is stored when one of the two pieces of compression data having the lower bit rate is compressed, one of the two pieces of compression data having the higher bit rate is expanded by said decoder, and thereafter one of said two pieces of compression data having the lower bit rate according to the rate control information is replaced with data re-compressed and generated by said second encoder according to said rate control information, and then recorded.

6. An image processing apparatus comprising:
an image device for generating a digital video signal from a sensor;
codecs for performing image compressing and expanding operations;
first and second recorders for recording outputs of said codecs in first and second recording media; and
a rate control information storage for use when data is compressed by said codec;
wherein said codecs generate two pieces of compression data having different bit rates on a time division basis, rate control information is stored when data is compressed by one of said two pieces of compression data having the lower bit rate, one of the two pieces of compression data having the higher bit rate is expanded by said codec is expanded by the codec switched between expanding and compression operations on a time division basis, and thereafter one of the two pieces of compression data having the lower bit rate according to the rate control information is replaced with data re-compressed and generated by the codec according to said rate control information, and then recorded.

7. An image processing apparatus according to claim 2, further comprising means for inputting information from a user, wherein one of the two pieces of compression data having the lower bit rate according to said user information in place of said rate control information is replaced with data re-compressed and generated by said codec.

8. An image processing apparatus comprising:
an image device for generating a digital video signal from a sensor;
a first encoder for performing image compressing operation over the digital video signal generated in said image device with a first bit rate;
a second encoder for performing image compressing operation over the digital video signal generated in the image device with a bit rate higher than said first bit rate;
first and second recorders for recording outputs of said first and second encoders in first and second recording media; and
a controller for performing controlling operation in such a manner that some or all of the compression data generated by the first encoder and recorded in the first recording medium is replaced with corresponding part of the compression data generated by the second encoder and recorded in the second recording medium according to information from a user.

9. An image processing apparatus according to claim 8, wherein said image device outputs the digital video signal of an HD size, said first encoder converts the digital video signal from an HD size to an SD size and performs image compressing operation over the digital video signal with the SD size, said second encoder performs image compressing operation over the digital video signal with the HD size, and said controller converts said corresponding replacement part from the HD size to the SD size and performs replacing operation.

10. An image processing apparatus according to claim 8, wherein said first encoder performs image compressing operation according to an MPEG2 system, said second encoder performs image compressing operation according to an H.264 format, said first recording medium is a DVD, and said second recording medium is a hard disk.
